(19) United States
(12) Patent Application Publication
(10) Pub. No.: US 2013/0033445 A1
(43) Pub. Date: Feb. 7, 2013

(54) TOUCH SENSING APPARATUS AND TOUCH SENSING METHOD

(71) Applicants: Wen-Tsung Lin, Tainan City (TW); Chen-Wei Yang, Kaohsiung City (TW)

(72) Inventors: Wen-Tsung Lin, Tainan City (TW); Chen-Wei Yang, Kaohsiung City (TW)

(21) Appl. No.: 13/563,041

(22) Filed: Jul. 31, 2012

(30) Foreign Application Priority Data
Aug. 2, 2011 (TW) 100127395

(51) Int. Cl. G06F 3/041

(52) U.S. Cl. 345/173; 178/18.03

(57) ABSTRACT

A touch sensing apparatus sensing a touch point on a touch panel through an ITO sensor is disclosed. The ITO sensor includes first lines arranged along a first direction and second lines arranged along a second direction. The touch sensing apparatus includes first pins, second pins, a driving/sensing control module, and a data processing module. The first pins are coupled to the first lines, and the second pins are coupled to the lines. At a first time, the driving/sensing control module outputs a driving voltage to the first pins and receives a first sensing signal from the second pins; at a second time, the driving/sensing control module outputs a driving voltage to the second pins and receives a second sensing signal from the first pins. The data processing module computes the first sensing signal and the second sensing signal to generate a touch point sensing result.

### BACKGROUND OF THE INVENTION

1. Field of the Invention

The invention relates to liquid crystal display (LCD); in particular, to a mutual capacitance touch sensing apparatus and touch sensing method having noise filtering function in time and space simultaneously, and effectively increasing the signal intensity to enhance the signal/noise ratio when the touch point is sensed.

2. Description of the Related Art

With the rapid progress of technology, the conventional display has been replaced by TFT-LCD gradually, and the TFT-LCD is widely used in various electronic products such as television, flat display, mobile, tablet PC, and projector. As to the TFT-LCD with touch control function, touch sensor is one of the important modules of the TFT-LCD, and the performance of the touch sensor will also directly affect the entire effectiveness of the TFT-LCD.

In general, the conventional LCD with mutual inductance capacitor touch function includes a display panel, an ITO sensor, and a touch control chip. Wherein, the ITO sensor includes a plurality of sensing lines and driving lines and the touch control chip includes a plurality of pins. The sensing lines are coupled to the pins respectively. After the driving line transmits a driving pulse and couples a small voltage at the sensing line, the touch control chip will sense the coupled voltage and judge whether the ITO sensor is touched according to the coupled voltage.

However, because a driving end and a sensing end of the conventional ITO sensor are independent; that is to say, the lines of the ITO sensor arranged in X direction are always used as sensing lines and the lines of the ITO sensor arranged in Y direction are always used as driving lines, or the lines of the ITO sensor arranged in X direction are always used as driving lines and the lines of the ITO sensor arranged in Y direction are always used as sensing lines. The noise interference suffered when sensing is mostly processed by a digital filter in the touch sensing apparatus to filter the analog-to-digital converted digital signal. Therefore, the conventional touch sensing apparatus can only provide the noise filtering function at time axis, but it fails to provide the noise filtering function at space axis, the signal/noise ratio when the touch point is sensed by the touch sensing apparatus is poor, and the sensing accuracy of touch point is also affected.

Therefore, the invention provides a touch sensing apparatus and a touch sensing method to solve the above-mentioned problems occurred in the prior arts.

### SUMMARY OF THE INVENTION

A scope of the invention is to provide a touch sensing apparatus. In an embodiment, the touch sensing apparatus senses a touch point on a touch panel through an ITO sensor. The ITO sensor includes a plurality of first lines arranged along a first direction and a plurality of second lines arranged along a second direction. The touch sensing apparatus includes a plurality of first pins, a plurality of second pins, a plurality of second pins, and a data processing module. The plurality of first pins is coupled to the plurality of first lines. The plurality of second pins is coupled to the plurality of second lines. The driving/sensing control module is coupled to the plurality of first pins and the plurality of second pins. The driving/sensing control module is used for outputting a driving voltage to the plurality of first pins and receiving a first sensing signal from the plurality of second pins at a first time, and outputting the driving voltage to the plurality of second pins and receiving a second sensing signal from the plurality of first pins at a second time. The data processing module is coupled to the driving/sensing control module and used for performing a computation on the first sensing signal and the second sensing signal to generate a touch point sensing result.

In an embodiment, the first direction and the second direction are vertical.

In an embodiment, the computation performed by the data processing module is a numerical computation performed on signal intensities of the first sensing signal and the second sensing signal, and the numerical computation is superposition computation, average computation, or weighted computation.

In an embodiment, the first time is earlier than the second time or the first time is later than the second time.

In an embodiment, at the first time, the plurality of first pins performs a driving function to output the driving voltage to the plurality of first lines to make the plurality of first lines worked as driving lines, and the plurality of second pins performs a sensing function to sense the first sensing signal from the plurality of second lines worked as sensing lines; at the second time, the plurality of second pins performs the driving function to output the driving voltage to the plurality of second lines to make the plurality of second lines worked as driving lines, and the plurality of first pins performs the sensing function to sense the second sensing signal from the plurality of first lines worked as sensing lines.

Another scope of the invention is to provide a touch sensing method. In an embodiment, the touch sensing method senses a touch point on a touch panel through an ITO sensor. The ITO sensor includes a plurality of first lines arranged along a first direction and a plurality of second lines arranged along a second direction. The touch sensing method includes steps of: at a first time, outputting a driving voltage to the plurality of first lines through the plurality of first pins and receiving a first sensing signal from the plurality of second lines through the plurality of second pins; at a second time, outputting the driving voltage to the plurality of second lines through the plurality of second pins and receiving a second sensing signal from the plurality of first lines through the plurality of first pins; performing a computation on the first sensing signal and the second sensing signal to generate a touch point sensing result.

In an embodiment, the first direction and the second direction are vertical.

In an embodiment, the computation is a numerical computation performed on signal intensities of the first sensing signal and the second sensing signal, and the numerical computation is superposition computation, average computation, or weighted computation.

In an embodiment, the first time is earlier than the second time or the first time is later than the second time.

In an embodiment, at the first time, the plurality of first pins performs a driving function to output the driving voltage to the plurality of first lines to make the plurality of first lines worked as driving lines, and the plurality of second pins performs a sensing function to sense the first sensing signal from the plurality of second lines worked as sensing lines; at the second time, the plurality of second pins performs the driving function to output the driving voltage to the plurality of second lines to make the plurality of second lines worked as driving lines, and the plurality of first pins performs the sensing function to sense the second sensing signal from the plurality of first lines worked as sensing lines.

Compared to the prior art, the touch sensing apparatus and the touch sensing method according to the invention switch the lines arranged along X direction and the lines arranged along Y direction of the ITO sensor to work as sensing lines or driving lines respectively at different times, and perform numerical computation on the intensities of the sensing signals sensed at different times. Therefore, the touch sensing apparatus of the invention can provide not only the noise filtering function at time axis, but also the noise filtering function at space axis to increase the sensing signal intensities, the signal/noise ratio when the touch point is sensed by the touch sensing apparatus will be effectively increased, and the sensing accuracy of touch point will be also enhanced.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates the touch sensing apparatus sensing a touch point on a touch panel through an ITO sensor at a first time.

FIG. 2 illustrates the eighty nodes K₀₀˜K₇₉ formed between the eight first lines and the ten second lines when m=7 and n=9.

FIG. 3 illustrates an embodiment of first sensed voltages corresponding to the eighty nodes K₀₀˜K₇₉ respectively at the first time.

FIG. 4 illustrates the touch sensing apparatus sensing a touch point on a touch panel through an ITO sensor at a second time.

FIG. 5 illustrates an embodiment of second sensed voltages corresponding to the eighty nodes K₀₀˜K₇₉ respectively at the second time.

FIG. 6 illustrates the super-positioned sensed voltages corresponding to the eighty nodes K₀₀˜K₇₉ respectively.

FIG. 7 illustrates the average sensed voltages corresponding to the eighty nodes K₀₀˜K₇₉ respectively.

FIG. 8 illustrates a flowchart of the touch sensing method of the invention.

### DETAILED DESCRIPTION

An embodiment of the invention is a touch sensing apparatus. In this embodiment, the touch sensing apparatus can be a mutual capacitance touch sensing apparatus, but not limited to this. The touch sensing apparatus of the invention switches the lines arranged along X direction and the lines arranged along Y direction of the ITO sensor to work as sensing lines or driving lines respectively at different times, and perform numerical computation (e.g., superposition or average) on the intensities of the sensing signals sensed at different times. Therefore, the touch sensing apparatus of the invention can have noise filtering function both at time axis and space axis at the same time to effectively increase signal intensities to largely enhance the signal/noise ratio when the touch point is sensed by the touch sensing apparatus.

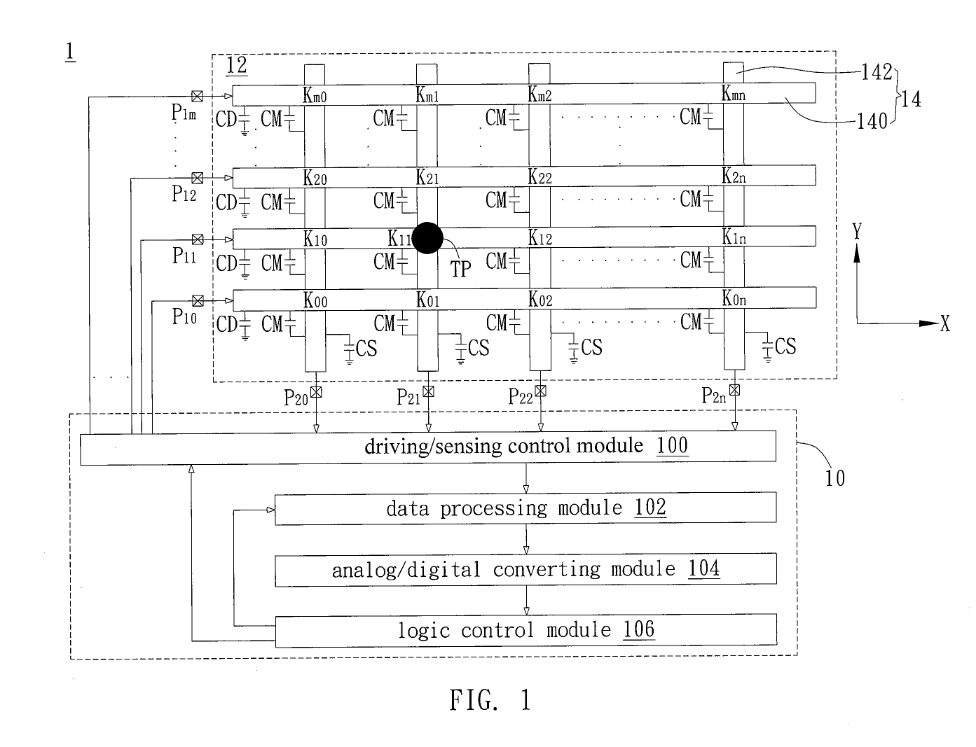

Please refer to FIG. 1. FIG. 1 illustrates a touch sensing apparatus 10 sensing a touch point on a touch panel 12 through an ITO sensor 14 at a first time. As shown in FIG. 1, the liquid crystal display 1 includes the touch sensing apparatus 10, the touch panel 12, and the ITO sensor 14. The touch panel 12 is usually adhered under the ITO sensor 14, but not limited to this. The touch sensing apparatus 10 includes (m+1) first pins P₁₀˜P₁ₘ, (n+1) second pins P₂₀˜₂ₙ, a driving/sensing control module 100, a data processing module 102, an analog/digital converting module 104, and a logic control module 106.

Wherein, the logic control module 106 is coupled to the driving/sensing control module 100 and the data processing module 102; the driving/sensing control module 100 is coupled to the (m+1) first pins P₁₀˜P₁ₘ, the (n+1) second pins P₂₀˜P₂ₙ, and the data processing module 102; the data processing module 102 is coupled to the analog/digital converting module 104; the analog/digital converting module 104 is coupled to the logic control module 106. CD represents the capacitance between the (m+1) first pins P₁₀˜P₁ₘ and the ground; CS represents the capacitance between the (n+1) second pins P₂₀˜P₂ₙ and the ground; CM represents the capacitance between the (m+1) first pins P₁₀˜P₁ₘ and the (n+1) second pins P₂₀˜P₂ₙ.

As shown in FIG. 1, the ITO sensor 14 includes (m+1) first lines 140 and (n+1) second lines 142, and the (m+1) first lines 140 and the (n+1) second lines 142 are vertical to each other. In this embodiment, the (m+1) first lines 140 are arranged in parallel along the X direction, the (n+1) second lines 142 are arranged in parallel along the Y direction, and the (m+1) (n+1) nodes K₀₀˜Kₘₙ are formed between the (m+1) first lines 140 and the (n+1) second lines 142, but not limited to this. The (m+1) first lines 140 are coupled to the (m+1) first pins P₁₀˜P₁ₘ respectively, and the (n+1) second lines 142 are coupled to the (n+1) second pins P₂₀˜P₂ₙ respectively, but not limited to this.

It should be noticed that the (m+1) first pins P₁₀˜P₁ₘ and the (n+1) second pins P₂₀˜P₂ₙ have more than one function, and they can be switched among different functions based on practical needs, such as driving function, sensing function, ground function, or floating function, but not limited to this.

In this embodiment, at the first time, the logic control module 106 of the touch sensing apparatus 10 will output a first driving/sensing control signal to the driving/sensing control module 100. The driving/sensing control module 100 will control the (m+1) first pins P₁₀˜P₁ₘ to perform driving function according to the first driving/sensing control signal to output the driving voltage to the (m+1) first lines 140 through the (m+1) first pins P₁₀˜P₁ₘ respectively, and control the (n+1) second pins P₂₀˜P₂ₙ to perform sensing function according to the first driving/sensing control signal to sense small coupling voltage on the (n+1) second lines 142 and output a first sensing signal to the driving/sensing control module 100.

In fact, the first sensing signal received by the driving/sensing control module 100 is analog data, such as sensed voltages corresponding to the (m+1) (n+1) nodes K₀₀˜Kₘₙ, but not limited to this.

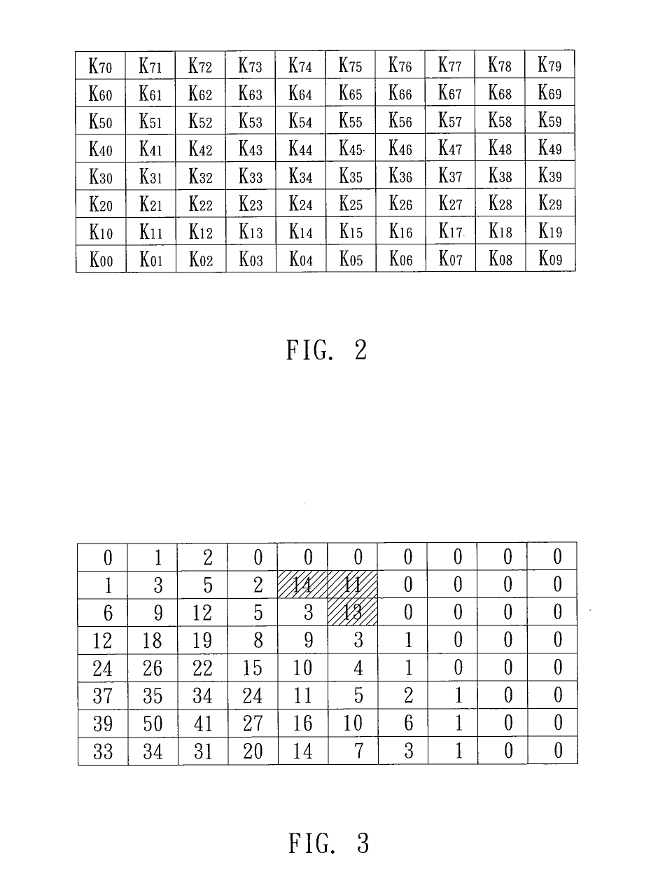

As shown in FIG. 2, it is assumed that m=7 and n=9, and eighty nodes K₀₀˜K₇₉ will be formed between the eight first lines 140 and the ten second lines 142. FIG. 3 illustrates an embodiment of first sensed voltages corresponding to the eighty nodes K₀₀˜K₇₉ respectively at the first time. After comparing FIG. 2 with FIG. 3, it can be found that at the first time, the first sensed voltage corresponding to the node K₁₁ is 50 mV and it is the maximum among all first sensed voltages. It represents that the touch point TP may be located at the node K₁₁. In addition, if a node is farer away from the touch point TP, the first sensed voltage corresponding to the node will be smaller in general; however, compared to the first sensed voltage corresponding to the adjacent nodes, the first sensed voltages corresponding to the nodes K₆₄, K₆₅, and K₅₅ shown in FIG. 3 are unusually high; therefore, they may be noises.

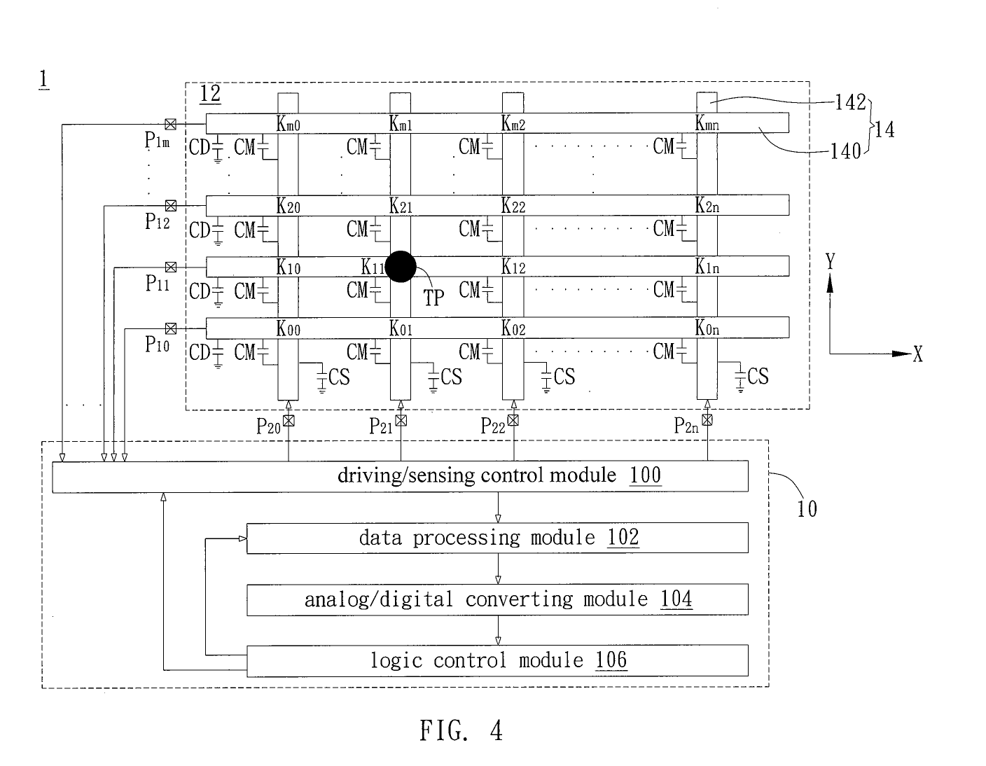

Then, as shown in FIG. 4, at the second time, the logic control module 106 of the touch sensing apparatus 10 will output a second driving/sensing control signal to the driving/sensing control module 100. The driving/sensing control module 100 will control the (n+1) second pins P₂₀˜P₂ₙ to perform driving function according to the second driving/sensing control signal to output the driving voltage to the (n+1) second lines 142 through the (n+1) second lines 142 respectively, and control the (m+1) first pins P₁₀˜P₁ₘ to perform sensing function according to the second driving/sensing control signal. The (m+1) first pins P₁₀˜P₁ₘ sense the small coupling voltage on the (m+1) first lines 140 and output the second sensing signal to the driving/sensing control module 100.

In fact, the second sensing signal received by the driving/sensing control module 100 is analog data, such as sensed voltages corresponding to the (m+1) (n+1) nodes K₀₀˜Kₘₙ, but not limited to this.

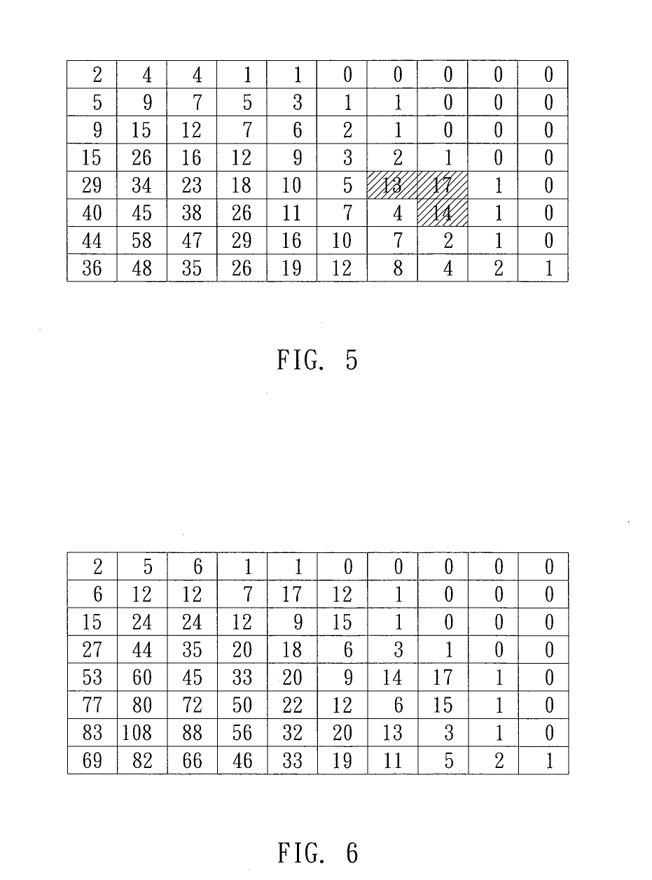

Similarly, it is assumed that m=7 and n=9, FIG. 5 illustrates an embodiment of second sensed voltages corresponding to the eighty nodes K₀₀˜K₇₉ respectively at the second time. After comparing FIG. 2 with FIG. 5, it can be found that at the second time, the second sensed voltage corresponding to the node K₁₁ is 58 mV and it is the maximum among all second sensed voltages. It represents that the touch point TP may be located at the node K₁₁. In addition, if a node is farer away from the touch point TP, the second sensed voltage corresponding to the node will be smaller in general; however, compared to the second sensed voltage corresponding to the adjacent nodes, the second sensed voltages corresponding to the nodes K₃₆, K₃₇, and K₂₇ shown in FIG. 5 are unusually high; therefore, they may be noises.

Then, the data processing module 102 will receive the first sensed voltages corresponding to the eighty nodes K₀₀˜K₇₉ from the driving/sensing control module 100 at the first time, and also receive the second sensed voltages corresponding to the eighty nodes K₀₀˜K₇₉ from the driving/sensing control module 100 at the second time. And then, the data processing module 102 will perform computation on the first sensed voltages and the second sensed voltages to obtain the computed sensed voltages corresponding to the eighty nodes K₀₀˜K₇₉ respectively to determine which node is the touch point TP located.

In practical applications, the data processing module 102 can perform numerical computation (e.g., superposition computation, average computation, or weighted computation) on the first sensed voltages and the second sensed voltages to obtain the computed sensed voltages corresponding to the eighty nodes K₀₀˜K₇₉ respectively, but not limited to this.

For example, FIG. 6 illustrates the super-positioned sensed voltages corresponding to the eighty nodes K₀₀˜K₇₉ respectively. As shown in FIG. 6, the data processing module 102 adds the first sensed voltages corresponding to the eighty nodes K₀₀˜K₇₉ respectively shown in FIG. 3 and the second sensed voltages corresponding to the eighty nodes K₀₀˜K₇₉ respectively shown in FIG. 5 to obtain the super-positioned sensed voltages corresponding to the eighty nodes K₀₀˜K₇₉ respectively as shown in FIG. 6.

It should be noticed that after this superposition computation, the difference between the super-positioned sensed voltage corresponding to the node K₁₁ which the touch point is located and other super-positioned sensed voltages corresponding to other nodes will become larger and more obvious. In addition, after this superposition computation, the difference between the noises occurred at the nodes K₆₄, K₆₅, and K₅₅ shown in FIG. 3 and the nodes K₃₆, K₃₇, and K₂₇ shown in FIG. 5 and other super-positioned sensed voltages corresponding to other nodes will become smaller and not so obvious. That is to say, the touch sensing apparatus 10 can provide not only the noise filtering function at time axis, but also the noise filtering function at space axis to increase the sensing signal intensities relative to the noises; therefore, the signal/noise ratio will be effectively increased, and the sensing accuracy of touch point sensed by the touch sensing apparatus 10 will be also enhanced.

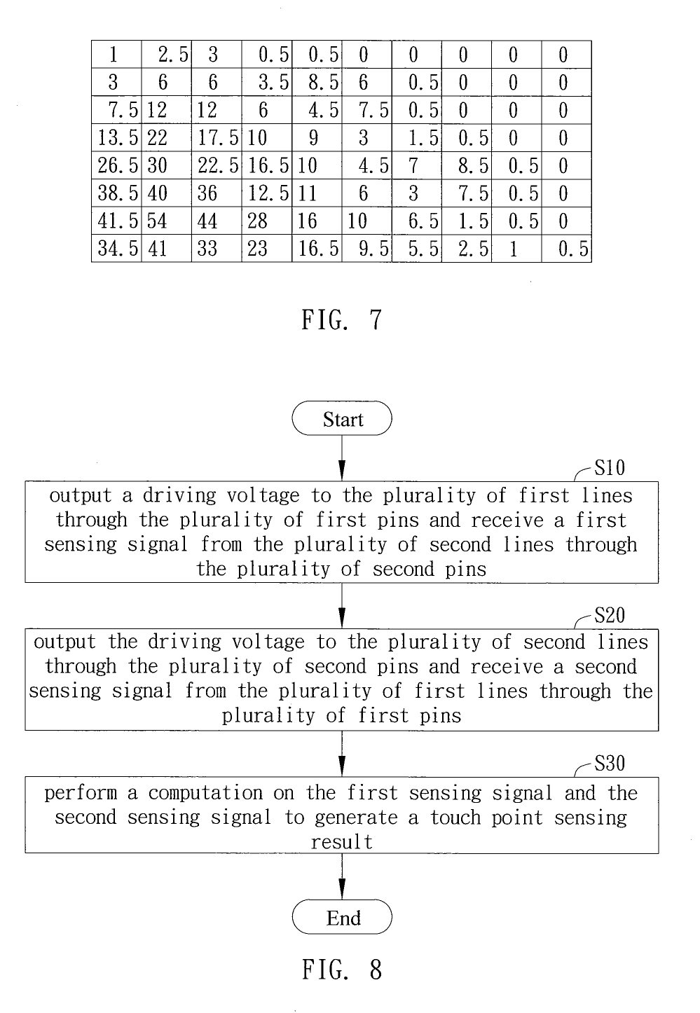

FIG. 7 illustrates the average sensed voltages corresponding to the eighty nodes K₀₀˜K₇₉ respectively. As shown in FIG. 7, the data processing module 102 averages the first sensed voltages corresponding to the eighty nodes K₀₀˜K₇₉ respectively shown in FIG. 3 and the second sensed voltages corresponding to the eighty nodes K₀₀˜K₇₉ respectively shown in FIG. 5 to obtain the average sensed voltages corresponding to the eighty nodes K₀₀˜K₇₉ respectively as shown in FIG. 7.

It should be noticed that after this average computation, the difference between the average sensed voltage corresponding to the node K₁₁ which the touch point is located and other average sensed voltages corresponding to other nodes will become larger and more obvious; therefore, the touch sensing apparatus 10 will determine that the touch point is located at the node K₁₁ more easily. In addition, after this average computation, the difference between the noises occurred at the nodes K₆₄, K₆₅, and K₅₅ shown in FIG. 3 and the nodes K₃₆, K₃₇, and K₂₇ shown in FIG. 5 and other average sensed voltages corresponding to other nodes will become smaller and not so obvious. That is to say, the touch sensing apparatus 10 can provide not only the noise filtering function at time axis, but also the noise filtering function at space axis to increase the sensing signal intensities relative to the noises; therefore, the signal/noise ratio will be effectively increased, and the sensing accuracy of touch point sensed by the touch sensing apparatus 10 will be also enhanced.

After the data processing module 102 obtains the computed sensed voltages corresponding to the eighty nodes K₀₀˜K₇₉ respectively, the analog/digital converting module 104 will convert the computed sensed voltages (analog data) into digital data and output the digital data to the logic control module 106. In fact, the analog/digital converting module 104 can be any types of analog/digital converter without any limitations.

Another embodiment of the invention is a touch sensing method. In this embodiment, the touch sensing method senses a touch point on a touch panel through an ITO sensor. The ITO sensor includes a plurality of first lines arranged along a first direction and a plurality of second lines arranged along a second direction. In fact, the first direction and the second direction are vertical, for example, the X direction and the Y direction are vertical, but not limited to this.

Please refer to FIG. 8. FIG. 8 illustrates a flowchart of the touch sensing method of the invention. As shown in FIG. 8, the touch sensing method includes the following steps. At the first time, the touch sensing method performs step S10 to output a driving voltage to the plurality of first lines through the plurality of first pins and receive a first sensing signal from the plurality of second lines through the plurality of second pins. In fact, at the first time, the plurality of first pins performs a driving function to output the driving voltage to the plurality of first lines to make the plurality of first lines worked as driving lines, and the plurality of second pins performs a sensing function to sense the first sensing signal from the plurality of second lines worked as sensing lines.

At the second time, the touch sensing method performs step S20 to output the driving voltage to the plurality of second lines through the plurality of second pins and receive a second sensing signal from the plurality of first lines through the plurality of first pins. In fact, at the second time, the plurality of second pins performs the driving function to output the driving voltage to the plurality of second lines to make the plurality of second lines worked as driving lines, and the plurality of first pins performs the sensing function to sense the second sensing signal from the plurality of first lines worked as sensing lines.

In practical applications, the first time and the second time are different, that is to say, the first time is earlier than the second time or the first time is later than the second time.

Then, the touch sensing method performs step S30 to perform a computation on the first sensing signal and the second sensing signal to generate a touch point sensing result. In fact, the computation performed by the data processing module is a numerical computation performed on signal intensities of the first sensing signal and the second sensing signal, and the numerical computation is superposition computation, average computation, or weighted computation, but not limited to this.

Compared to the prior art, the touch sensing apparatus and the touch sensing method according to the invention switch the lines arranged along X direction and the lines arranged along Y direction of the ITO sensor to work as sensing lines or driving lines respectively at different times, and perform numerical computation on the intensities of the sensing signals sensed at different times. Therefore, the touch sensing apparatus of the invention can provide not only the noise filtering function at time axis, but also the noise filtering function at space axis to increase the sensing signal intensities, the signal/noise ratio when the touch point is sensed by the touch sensing apparatus will be effectively increased, and the sensing accuracy of touch point will be also enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch sensing apparatus, sensing a touch point on a touch panel through an ITO sensor, the ITO sensor comprising a plurality of first lines arranged along a first direction and a plurality of second lines arranged along a second direction, the touch sensing apparatus comprising:
a plurality of first pins, coupled to the plurality of first lines;
a plurality of second pins, coupled to the plurality of second lines;
a driving/sensing control module, coupled to the plurality of first pins and the plurality of second pins, for outputting a driving voltage to the plurality of first pins and receiving a first sensing signal from the plurality of second pins at a first time, and outputting the driving voltage to the plurality of second pins and receiving a second sensing signal from the plurality of first pins at a second time; and
a data processing module, coupled to the driving/sensing control module, for performing a computation on the first sensing signal and the second sensing signal to generate a touch point sensing result.

2. The touch sensing apparatus of claim 1, wherein the first direction and the second direction are vertical.

3. The touch sensing apparatus of claim 1, wherein the computation performed by the data processing module is a numerical computation performed on signal intensities of the first sensing signal and the second sensing signal, and the numerical computation is superposition computation, average computation, or weighted computation.

4. The touch sensing apparatus of claim 1, wherein the first time is earlier than the second time or the first time is later than the second time.

5. The touch sensing apparatus of claim 1, wherein at the first time, the plurality of first pins performs a driving function to output the driving voltage to the plurality of first lines to make the plurality of first lines worked as driving lines, and the plurality of second pins performs a sensing function to sense the first sensing signal from the plurality of second lines worked as sensing lines; at the second time, the plurality of second pins performs the driving function to output the driving voltage to the plurality of second lines to make the plurality of second lines worked as driving lines, and the plurality of first pins performs the sensing function to sense the second sensing signal from the plurality of first lines worked as sensing lines.

6. A touch sensing method, for sensing a touch point on a touch panel through an ITO sensor, the ITO sensor comprising a plurality of first lines arranged along a first direction and a plurality of second lines arranged along a second direction, the touch sensing method comprising steps of:
at a first time, outputting a driving voltage to the plurality of first lines through the plurality of first pins and receiving a first sensing signal from the plurality of second lines through the plurality of second pins;
at a second time, outputting the driving voltage to the plurality of second lines through the plurality of second pins and receiving a second sensing signal from the plurality of first lines through the plurality of first pins; and
performing a computation on the first sensing signal and the second sensing signal to generate a touch point sensing result.

7. The touch sensing method of claim 6, wherein the first direction and the second direction are vertical.

8. The touch sensing method of claim 6, wherein the computation is a numerical computation performed on signal intensities of the first sensing signal and the second sensing signal, and the numerical computation is superposition computation, average computation, or weighted computation.

9. The touch sensing method of claim 6, wherein the first time is earlier than the second time or the first time is later than the second time.

10. The touch sensing method of claim 6, wherein at the first time, the plurality of first pins performs a driving function to output the driving voltage to the plurality of first lines to make the plurality of first lines worked as driving lines, and the plurality of second pins performs a sensing function to sense the first sensing signal from the plurality of second lines worked as sensing lines; at the second time, the plurality of second pins performs the driving function to output the driving voltage to the plurality of second lines to make the plurality of second lines worked as driving lines, and the plurality of first pins performs the sensing function to sense the second sensing signal from the plurality of first lines worked as sensing lines.
